(19) United States
(12) Patent Application Publication
(10) Pub. No.: US 2006/0135028 A1
(43) Pub. Date: Jun. 22, 2006

(54) Substrate for a display and method for manufacturing the same

(76) Inventors: Andreas Klyszcz, Berlin (DE); Marcus Schaedig, Wusterhausen (DE); Werner Humbs, Berlin (DE)

Correspondence Address: ROBERT E. BUSHNELL, 1522 K STREET NW, SUITE 300, WASHINGTON, DC, 20005-1202, US

(21) Appl. No.: 11/293,509

(22) Filed: Dec. 5, 2005

(30) Foreign Application Priority Data
Dec. 7, 2004 (EP) 04078333.4
Jun. 16, 2005 (KR) 10-2005-0051914

(51) Int. Cl. H01J 9/24; H01J 9/00

(52) U.S. Cl. 445/24

(57) ABSTRACT

A substrate for a plasma display panel (PDP) having a plurality of ink-jet printed conductive lines for address and bus electrodes, and a method of manufacturing the substrate are provided. The method includes applying metal adhesion promoter layer to a ground substrate, applying a layer of fluorinated precursors, and applying a plurality of conductive lines. The adhesion of the ink-jet printed conductive lines, i.e. ink-jet printed address and bus electrodes to the ground substrate, and the contact angle of the ink-jet printed conductive lines with respect to the ground substrate are improved, enabling a high resolution display to be manufactured.

### CROSS-REFERENCE TO RELATED PATENT APPLICATION AND CLAIM OF PRIORITY

This application claims the benefit of European Patent Application No. 04078333.4, filed on Dec. 7, 2004, in the European Intellectual Property Office, and Korean Patent Application No. 10-2005-0051914, filed on Jun. 16, 2005, in the Korean Intellectual Property Office, the disclosure of which is incorporated herein in its entirety by reference.

### BACKGROUND OF THE INVENTION

1. Field of the Invention

The present invention relates to a substrate for a display having a plurality of ink-jet printed conductive lines and a method for manufacturing the same. More particularly, the present invention relates to a substrate for a plasma display panel (PDP) having a plurality of ink-jet printed conductive lines for address and bus electrodes.

2. Description of the Related Art

Ink-jet printed bus and address electrodes in PDPs are printed with nano particle ink. Silver nano particle ink is composed of individually dispersed metal nano particles, surfactants and organic particles (EP patent No. 1349135A1, US Patent Publication No. 20040043691A1).

US Patent Publication No. 20040038616A1 describes a method of manufacturing a substrate for a flat panel display, the method including: forming a plurality of grooves on the bottom of a float glass substrate by a subtractive process to form barrier ribs including protrusions between the individual grooves, and then forming electrodes on the bottoms of the grooves by an ink-jet process or a dispersing process. An alternative process of forming narrow metal lines on glass or an indium tin oxide (ITO) surface with nano particle ink is to treat the substrate moderately to have a contact angle of 600 for the nano particle ink (US Patent Publication No. 20030083203A1 to Takashi Hashimoto et. al, SID 02 Digest, 753-755). In conventional surface treatment methods, like fluorination with CF₄, C₂F₆, C₃F₈ or fluoroalkyl-functionalized silanes, the contact angles of 20° to 60° can be achieved, but the drawback is a loss in adhesion of the printed and cured metal lines.

Korean Patent Publication Gazette No. 0229232 describes a droplet deposition on a hydrophobized substrate. The hydrophobization is realized using silane compounds, such as hexamethyldisilazane (HMDS), PHAMS, adenosine monophosphate (AMP), or polyether sulfone (PES), and can be applied to PDPs.

Furthermore, Korean Patent Laid-Open Gazette No. 2003-0084608 discloses a fluid, which contains metal particles and that is deposited and controlled on the surface of a substrate. An intermediate film of the fluid material has been formed to be an electrical contact. Here, fluoroalkylated silanes are used to form a self-assembled monolayer (SAM). The manufacturing of a field emission display (FED) is also disclosed therein. A pair of electrodes contacts a conductive thin film on a substrate. This film is realized by a “droplet-method” using a metal-based fluid (Korean Patent Publication Gazette No. 0229232). A conductive thin film is formed by releasing a fluid containing metal particles onto a substrate. The release of the intermediate fluid results in an intermediate thin film on the substrate, which improves the adhesion between the substrate and the conductive film (Korean Patent Laid-Open Gazette No. 2003-0084608).

An organic fluid is used to yield a thin film patterned layer (U.S. Pat. No. 6,677,238)

### SUMMARY OF THE INVENTION

The present invention relates to improving the adhesion of ink-jet printed conductive lines, for example, ink-jet printed address and bus electrodes, to a ground substrate. The present invention relates to improving the contact angle of ink jet printed conductive lines with respect to a ground substrate so as to implement a high resolution display.

According to an aspect of the present invention, there is provided a method of manufacturing a substrate for a display having a plurality of conductive lines, the method including: forming at least one intermediate layer on a ground substrate by applying metal adhesion promoters and fluorinated precursors; and applying a plurality of conductive lines to said at least one layer.

At least one intermediate layer can be introduced between the ground substrate and the conductive lines so as to improve the adhesion and the contact angle of ink-jet printed conductive lines to a ground substrate. The metal adhesion promoter layers and the layer of fluorinated precursors can be sequentially applied, resulting in two intermediate layers. Alternatively, the metal adhesion promoter layers and the layer of fluorinated precursors may be simultaneously deposited, resulting in one layer contacting the metal adhesion promoter silanes and the fluorinated precursors. Such a layer can be manufactured by the self-assembly of metal adhesion promoter silanes in the presence of fluorinated precursors.

The formation of the mono layer may include dipping the ground substrate into a solution containing the substances of Formula (IV) and fluorinated organic molecules having functional groups comprising at least amine, diamine, triamine, tetraamine, polyamine, pyridine, imidazole, carboxylic acid, sulfonic acid, phosphate, phosphonate, and/or phenol:
R′″SiX₄ (IV)

where each R′″ of the substances of Formula (IV) is selected from the group consisting of a H-atom, an OH-group, a Cl-atom and an alkoxy group, and each X of Formula (IV) is independently selected from the group consisting of a H-atom, an OH-group, a Cl-atom, an alkoxy group, an alkyl group and/or an organic group comprising at least one metal binding group.

Fluorinated organic molecules having functional groups including at least one of amine, diamine, triamine, tetraamine, polyamine, polyamid, pyridine, imidazole, carboxylic acid, sulfonic acid, phosphate, phosphonate, and phenol may be used as the fluorinated precursors. The fluorinated precursors may be applied by a wet chemistry process.

The metal adhesion promoters may be applied by:

a plasma treatment using NH₃, H₂S, and/or PH₃;

a plasma treatment using a substance of Formula (I):
YRₙ n=2 or 3 (I)
where Y is a N-, S- or P-atom, and each R is independently a H-atom and/or an alkyl group;

plasma polymerization using a substance of Formula (II):
ZR′ₘ m=2 or 3 (II)
where Z is a N-, S- or P-atom, and each R′ is independently a H-atom and/or a silane group of Formula (III), and at least one R′ is the silane group of Formula (III):
   SiR″₃ (III)
   where each R″ is independently an alkyl group; or a wet chemical process with a substance of Formula (IV):
      R′″SiX₄ (IV)
where R′″ is a H-atom, an OH-group, a Cl-atom and/or an alkoxy group, and each X is independently a H-atom, an OH-group, a Cl-atom, an alkoxy group, an alkyl group and/or an organic group including at least one metal binding group.

The plasma polymerization may be a polymerization of hexamethyldisilazane.

According to the present invention, when two intermediate layers (a metal adhesion promoter layer and a layer of fluorinated precursors) are formed, the metal adhesion promoter layer is applied, and then the layer of fluorinated precursors is applied.

The metal adhesion promoter layer and the layer of fluorinated precursors may be applied as a monolayer or a dilayer, and/or with a thickness of 1 to 10 nm.

According to another aspect of the present invention, there is provided a substrate including a ground substrate having a plurality of conductive lines wherein at least one layer is formed between the ground substrate and the conductive lines. The conductive lines may include metal nano powders having a particle size of 1 to 100 nm. The metal adhesion promoter layer may include crosslinked molecules of Formula (II) (for example, hexamethyldisilazane) or crosslinked silanes of Formula (IV). The layer of fluorinated precursors may include crosslinked fluorinated organic molecules. The metal adhesion promoters and the fluorinated precursors may be sequentially disposed upon one another. Alternatively, the metal adhesion promoter layer and the layer of fluorinated precursors may be formed as one layer including crosslinked molecules of Formula (IV) or crosslinked silanes of Formula (II) (e.g. hexamethyldisilazane) and crosslinked organic molecules. In this case, the molecules of Formula (II) (e.g. hexamethyldisilazane) or silanes of Formula (VI) and the fluorinated organic molecules are dispersed side by side.

### BRIEF DESCRIPTION OF THE DRAWINGS

A more complete appreciation of the present invention, and many of the above and other features and advantages of the present invention, will be readily apparent as the same becomes better understood by reference to the following detailed description when considered in conjunction with the accompanying drawings in which like reference symbols indicate the same or similar components, wherein:

FIG. 1 and FIG. 2 are sectional views for explaining essential steps in methods of manufacturing a substrate for a display according to embodiments of the present invention, in which a metal adhesion promoter layer and a layer of fluorinate precursors are sequentially disposed upon one another; and

FIG. 3 is a sectional view for explaining essential steps in a method of manufacturing a substrate for a display according to an embodiment of the present invention, in which the metal adhesion promoter layer and the layer of fluorinated precursors are simultaneously applied.

### DETAILED DESCRIPTION OF THE INVENTION

Hereafter, the present invention will now be exemplarily described with reference to the attached drawings.

According to an embodiment of the present invention, a method of manufacturing a substrate for a display having a plurality of conductive lines includes forming at least one intermediate layer between a ground substrate and a plurality of conductive lines by applying metal adhesion promoters and fluorinated precursors.

At least one intermediate layer can be introduced between the ground substrate and the conductive lines so as to improve the adhesion and the contact angle of ink-jet printed conductive lines to a ground substrate. The metal adhesion promoters and the fluorinated precursors can be sequentially applied, resulting in two intermediate layers of the first layer having the metal adhesion promoters and the second layer having the fluorinated precursors. Alternatively, the metal adhesion promoters and the fluorinated precursors may be simultaneously deposited, resulting in one layer containing the metal adhesion promoter silanes and the fluorinated precursors. Such a layer can be manufactured by the self-assembly of metal adhesion promoter silanes in the presence of fluorinated precursors.

Fluorinated organic molecules having functional groups including at least one of amine, diamine, triamine, tetraamine, polyamine, polyamid, pyridine, imidazole, carboxylic acid, sulfonic acid, phosphate, phosphonate, and phenol may be used as the fluorinated precursors. The fluorinated precursors may be applied by a wet chemistry process.

The metal adhesion promoters may be applied by:

a plasma treatment using NH₃, H₂S, and/or PH₃;

a plasma treatment using a substance of Formula (I):
YRₙ n=2 or 3 (I)
where Y is a N—, S- or P-atom, and each R is independently a H-atom and/or an alkyl group;

plasma polymerization using a substance of Formula (II):
ZR′ₘ m=2 or 3 (II)
where Z is a N-, S- or P-atom, and each R′ is independently a H-atom and/or a silane group of Formula (III), and at least one R′ is the silane group of Formula (III):
   SiR″₃ (III)
   where each R″ is independently an alkyl group; or a wet chemical process with a substance of Formula (IV):
      R′″ SiX₄ (IV)
where R′″ is a H-atom, an OH-group, a Cl-atom and/or an alkoxy group, and each X is independently a H-atom, an OH-group, a Cl-atom, an alkoxy group, an alkyl group and/or an organic group including at least one metal binding group.

The organic group including at least one metal binding group may include amine, diamine, triamine, tetraamine, polyamine, amide, polyamid, hydrazine, pyridine, imidazole, thiophene, carboxylic acid, carboxylic acid halogenide, sulfide, disulfide, trisulfide, tetrasulfide, polysulfide, sulfonic acid, sulfonic acid halogenide, phosphate, phosphonate, epoxide, phenol and/or polyether.

The plasma polymerization may be a polymerization of hexamethyldisilazane.

According to an embodiment of the present invention, when two intermediate layers (a metal adhesion promoter layer (i.e., a first layer) and a layer of fluorinated precursors (i.e., a second layer) are formed, the metal adhesion promoter layer is applied, and then the layer of fluorinated precursors is applied.

The above-described methods results in intermediate layers which lead to ink-jet printed conductive lines causing an improvement in the contact angle of a ink droplet with respect to the substrate, which is important for final resolution, and improved adhesion of the cured conductive, i.e. metal lines. Therefore, the adhesion of the ink-jet printed address and bus electrodes to the ground substrate is much stronger and fulfills process requirements in manufacturing PDPs.

The metal adhesion promoter layer and the layer of fluorinated precursors may be applied as a monolayer or a dilayer, and/or with a thickness of 1 to 10 nm. In this case, the metal adhesion promoters and the fluorinated precursors are formed as one intermediate layer including molecules of Formula (IV) or molecules of Formula (II) (for example, hexamethyldisilazane) and organic molecules having functional groups including at least amine, diamine, triamine, tetraamine, polyamine, pyridine, imidazole, carboxylic acid, sulfonic acid, phosphate, phosphonate and/or phenol which are crosslinked and dispersed side by side. The intermediate layer may have a thickness of 1 to 10 nm.

The ground substrate may be a flat and/or flexible glass substrate, an indium tin oxide (ITO) coated glass substrate or a polymer substrate. The plurality of conductive lines is preferably applied by ink-jet printing. The ink may be comprised of a liquid solution of dispersed metal nano powders and a solvent. The metal may be silver, gold, platinum, palladium or copper. The ink may include an additive comprised of metal-stabilizing organic polymers.

According to another aspect of the present invention, there is provided a substrate including a ground substrate having a plurality of conductive lines wherein a metal adhesion promoter layer and a layer of fluorinated precursors are disposed between the ground substrate and the conductive lines. The conductive lines may include metal nano powders having a particle size of 1 to 100 nm. The metal adhesion promoter layer may include crosslinked molecules of Formula (II) (for example, hexamethyldisilazane) or crosslinked silanes of Formula (IV). The layer of fluorinated precursors may include crosslinked fluorinated organic molecules.

The metal adhesion promoters and the fluorinated precursors may be sequentially disposed upon one another. Alternatively, the metal adhesion promoter layer and the layer of fluorinated precursors may be formed as one layer including crosslinked molecules of Formula (II) (e.g. hexamethyldisilazane) or crosslinked silanes of Formula (IV) and crosslinked organic molecules. In this case, the molecules of Formula (II) (e.g. hexamethyldisilazane) or silanes of Formula (VI) and the fluorinated organic molecules are dispersed side by side.

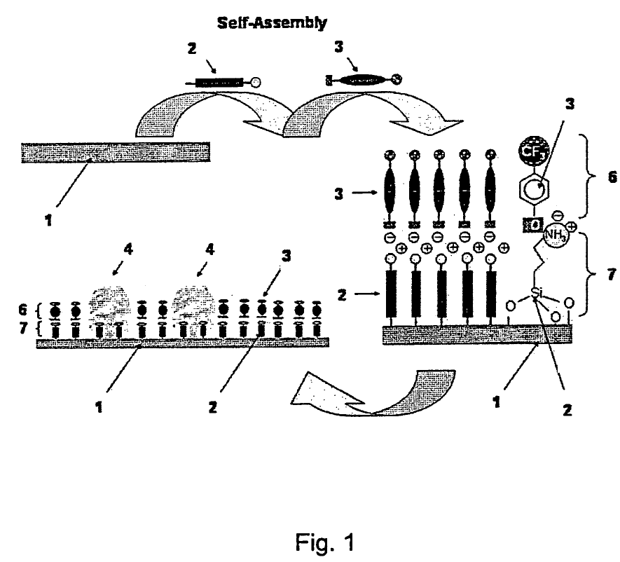

A typical process of manufacturing an adhesion promoting and line width positioning intermediate layer according to an embodiment of the present invention will now be described with reference to FIG. 1.

An indium tin oxide (ITO) coated glass ground substrate 1 undergoes a two-step self-assembly process. In a first step, the substrate is dipped for 10 to 90 seconds into a 10⁻¹ to 10⁻⁵ mol/l solution of a metal adhesion promoter silane 2 (3-aminopropyl) triethoxysilane, dried at 50 to 200° C. for 1 to 60 minutes and cooled down to room temperature. Thereby, the layer 7 of metal adhesion promoter silanes is obtained. In a second step, the substrate is dipped for 10 to 90 seconds into a 10⁻¹ to 10⁻⁵ mol/l solution of a fluorinated precursor 3 (4-hydroxylbenzotrifluoride) and dried at 50 to 200° C. for 1 to 60 minutes. Thereby, the layer 6 of fluorinated precursors is obtained. The final resolution of ink-jet printed conductive address and bus electrodes (i.e. conductive lines 4) can be controlled by reducing the surface energy with fluorinated precursors 3. This surface treatment also enables ink-jet printed metal nano-particle 4 (e.g. silver nano-particle) to be crosslinked to specific metal adhesion promoting functional groups like an amino group. The fluorinated precursors 3 reduce the surface energy so as to ensure a specific line resolution. Finally, silver nano ink including silver nano particles 4 is ink-jet printed using a multi-nozzle ink-jet printer. The ink-jet printed substrate is dried and heat-treated at 250° C. for 20 minutes, so that the ink-jet printed lines 4 become conductive.

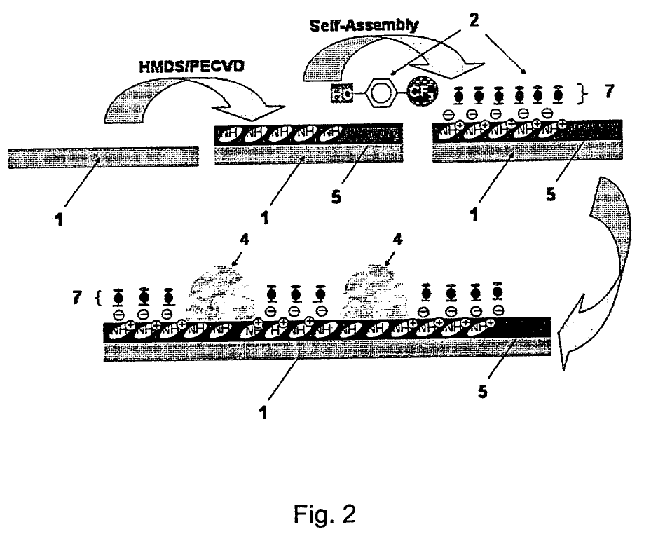

A process of manufacturing an adhesion promoting and line width positioning intermediate layer according to another embodiment of the present invention will be described with reference to FIG. 2. Instead of the metal adhesion promoter silane 2, polymerized hexamethyldisilazane (HMDS) is applied by plasma enhanced chemical vapor deposition (PECVD) as a metal adhesion promoter which results in the layer 5 of polymerized HMDS.

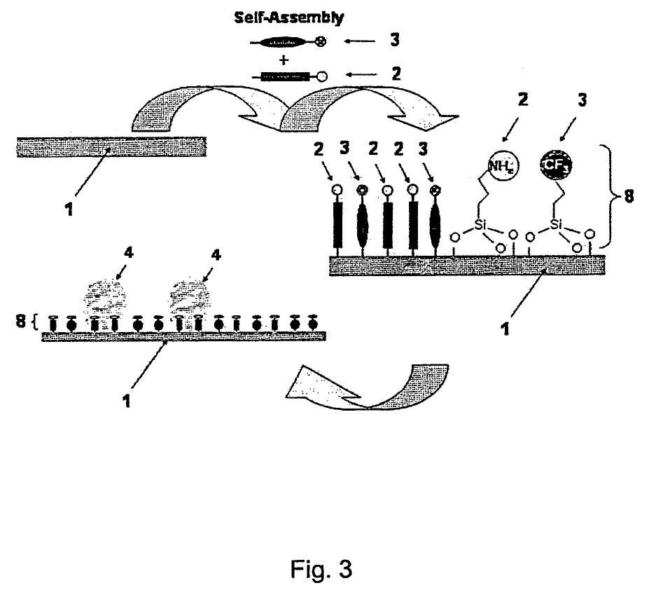

In addition to the two-step self-assembly process of metal adhesion promoter silanes and fluorinated precursor and the two-step HMDS/fluorinated precursor treatment (see FIG. 1 and FIG. 2), the intermediate layer can also be introduced by a self-assembly process of metal adhesion promoter silanes 2 in the presence of fluorinated precursors 3 (see FIG. 3). Thereby the layer 8 of metal adhesion promoter silanes and fluorinated precursors is obtained. A mixed self-assembled monolayer (MSAM) realizes the final resolution of the ink-jet printed address and bus electrodes (i.e. lines 4) by controlling the surface energy of the substrate and simultaneously ensuring an improved adhesion.

In principle, the presence of a crosslinked macromolecular structure using Si—C—Si. Si—N—C and C—N—C linkages (like in the case of HMDS) or metal adhesion promoting organic functional groups based on C—N, C—O, C—S, C—P, Si—N, Si—O, Si—S and Si—P can be detected by Electron Spectroscopy for Chemical Analysis (ESCA) and Attenuated Total Reflectance Fourier Transform Infrared Spectroscopy (ATR-FTIR)

Finally, the silver nano ink including the silver nano particles 4 is ink-jet printed on the layer 8 using the multi-nozzle ink-jet printer. The ink-jet printed substrate is dried and heat-treated at 10 to 250° C. for 20 minutes, so that the ink-jet printed lines 4 become conductive. The substrates (upper and lower substrates) can be subjected to further process steps for manufacturing a plasma display panel (PDP).

In a substrate for a display and a method for manufacturing the substrate according to the present invention as described above, the adhesion of the ink-jet printed conductive lines, like ink-jet printed address and bus electrodes, on the ground substrate is improved, the ink-jet printed conductive lines enabling a high resolution display is provided on the ground substrate.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of manufacturing a substrate for a display having a plurality of conductive lines, the method comprising:
forming at least one layer on a ground substrate by applying metal adhesion promoters and fluorinated precursors; and
applying a plurality of conductive lines to said at least one layer.

2. The method of claim 1, wherein the metal adhesion promoters is applied by:
a plasma treatment using NH₃, H₂S, and/or PH₃;
a plasma treatment using a substance of Formula (I):
YRₙ n=2 or 3 (I)
where Y is a N-, S- or P-atom and each R is independently selected from the group consisting of a H-atom and an alkyl group; or
a plasma polymerization using a silane of Formula (II):
ZR′ₘ m=2 or 3 (II)
where Z is a N-, S- or P-atom, and each R′ is independently selected from the group consisting of a H-atom and a silane group of Formula (III), and at least one R′ is the silane group of Formula (III):
SiR″₃ (III)
where each R″ is independently an alkyl group.

3. The method of claim 1, wherein the metal adhesion promoters comprise substances of Formula (IV):
R′″SiX₄ (IV)
where each R′″ of the substances of Formula (IV) is independently selected from the group consisting of a H-atom, an OH-group, a Cl-atom and an alkoxy group, and each X of Formula (IV) is independently selected from the group consisting of a H-atom, an OH-group, a Cl-atom, an alkoxy group, an alkyl group and an organic group comprising at least one metal binding group.

4. The method of claim 3, wherein the organic group comprising at least one metal biding group is selected from the group consisting of amine, diamine, triamine, tetraamine, polyamine, amide, polyamid, hydrazine, pyridine, imidazole, thiophene, carboxylic acid, carboxylic acid halogenide, sulfide, disulfide, trisulfide, tetrasulfide, polysulfide, sulfonic acid, sulfonic acid halogenide, phosphate, phosphonate, epoxide, phenol and polyether.

5. The method of claim 3, wherein the metal adhesion promoters are applied by a wet chemistry process.

6. The method of claim 5, wherein the metal adhesion promoters are applied by dipping the ground substrate into a solution of substances of Formula (I):
YRₙ n=2 or 3 (I)
where Y is a N-, S- or P-atom, and each R is independently selected from the group consisting of a H-atom and an alkyl group.

7. The method of claim 1, wherein the fluorinated organic molecules have functional groups comprising at least amine, diamine, triamine, tetraamine, polyamine, pyridine, imidazole, carboxylic acid, sulfonic acid, phosphate, phosphonate, and phenol.

8. The method of claim 7, wherein the fluorinated precursors are applied by a wet chemistry process.

9. The method of claim 7, wherein the fluorinated precursors are applied by dipping the ground substrate into a solution of the fluorinated organic molecules having the functional groups.

10. The method of claim 9, wherein the concentration of the fluorinated organic molecules in the solution is in a range of 10⁻¹ to 10⁻⁵ mol/l.

11. The method of claim 9, wherein the concentration of fluorinated organic molecules in the solution is in a range of 10⁻¹ to 10⁻⁵ mol/l.

12. The method of claim 1, wherein the formation of said at least one layer comprises forming a mono layer by simultaneously applying the metal adhesion promoters and the fluorinated precursors.

13. The method of claim 12, wherein the formation of the mono layer comprises dipping the ground substrate into a solution containing the substances of Formula (IV) and the fluorinated organic molecules having functional groups comprising at least amine, diamine, triamine, tetraamine, polyamine, pyridine, imidazole, carboxylic acid, sulfonic acid, phosphate, phosphonate, and/or phenol:
R′″SiX₄ (IV)
where each R′″ of the substances of Formula (IV) is selected from the group consisting of a H-atom, an OH-group, a Cl-atom and an alkoxy group, and each X of Formula (IV) is independently selected from the group consisting of a H-atom, an OH-group, a Cl-atom, an alkoxy group, an alkyl group and an organic group comprising at least one metal binding group.

14. The method of one of claim 12, wherein the mono layer has a thickness of 1 to 10 nm.

15. The method of claim 1, wherein the formation of said at least one layer comprises forming a first layer comprising the metal adhesion promoters and, after forming the first layer, forming a second layer comprising the fluorinated precursors.

16. The method of claim 1, wherein the plurality of conductive lines is applied by ink-jet printing.

17. The method of claim 16, wherein the ink-jet printing utilizes ink comprising a liquid solution of at least one of dispersed metal nano powders and dispersed metal nano-composites and a solvent.

18. The method of claim 17, wherein the metal of said at least one of dispersed metal nano powders and dispersed metal nano-composites is silver, gold, platinum, palladium, or copper.

19. The method of claim 17, wherein the ink comprises an additive comprising metal stabilizing organic polymers.

20. A substrate for a display, comprising:
a ground substrate;
at least one layer formed on the ground substrate, said at least one layer having metal adhesion promoters and fluorinated precursors; and
a plurality of the conductive lines printed on said at least one layer formed on the ground substrate.

21. The substrate of claim 20, wherein the plurality of conductive lines comprises sintered metal nano powders having a particle size of 1 to 100 nm.

22. The substrate of claim 20, wherein the metal adhesion promoters comprise at least one of crosslinked molecules of Formula (I), crosslinked molecules of Formula (II), and crosslinked molecules of Formula (IV):
YRₙ n=2 or 3 (I)
where Y is a N-, S- or P-atom and each R is independently selected from the group consisting of a H-atom and an alkyl group;
ZR′ₘ m=2 or 3 (II)
where Z is a N-, S- or P-atom and each R′ is independently selected from the group consisting of a H-atom and a silane group of Formula (III), and at least one R′ is the silane group of Formula:
SiR″₃ (III)
where each R″ is independently an alkyl group; and
R′″SiX₄ (IV)
where R′″ is selected from the group consisting of a H-atom, an OH-group, a Cl-atom and an alkoxy group, and each X is independently selected from the group consisting of a H-atom, an OH-group, a Cl-atom, an alkoxy group, an alkyl group and an organic group comprising at least one metal binding group.

23. The substrate of claim 20, wherein the fluorinated precursors comprise crosslinked fluorinated organic molecules having functional groups comprising at least amine, diamine, triamine, tetraamine, polyamine, pyridine, imidazole, carboxylic acid, sulfonic acid, phosphate, phosphonate, and phenol.

24. The substrate of claim 20, wherein said at least one layer comprises a first layer comprising the metal adhesion promoters, and a second layer comprising the fluorinated precursors.

25. The substrate of claim 20, wherein said at least one layer comprises a mono layer comprising the metal adhesion promoters and the fluorinated precursors.

26. The substrate of claim 20, wherein said metal adhesion promoters comprise molecules of Formula (I), Formula (II) or Formula (VI), and the fluorinated precursors have functional groups comprising at least amine, diamine, triamine, tetraamine, polyamine, pyridine, imidazole, carboxylic acid, sulfonic acid, phosphate, phosphonate, and/or phenol which are crosslinked and disposed side by side:
YRₙ n=2 or 3 (I)
where Y is a N—, S- or P-atom and each R is independently selected from the group consisting of a H-atom and an alkyl group;
ZR′ₘ m=2 or 3 (II)
where Z is a N—, S- or P-atom and each R′ is independently selected from the group consisting of a H-atom and a silane group of Formula (III), and at least one R′ is the silane group of Formula (III):
SiR″₃ (III)
where each R″ is independently an alkyl group; and
R′″ SiX₄ (IV)
where R′″ is selected from the group consisting of a H-atom, an OH-group, a Cl-atom and an alkoxy group, and each X is independently selected from the group consisting of a H-atom, an OH-group, a Cl-atom, an alkoxy group, an alkyl group and an organic group comprising at least one metal binding group.

27. A substrate for a display, comprising:
a ground substrate;
at least one layer formed on the ground substrate, said at least one layer comprising:
metal adhesion promoters comprising at least one of crosslinked molecules of Formula (I), crosslinked molecules of Formula (II), and crosslinked molecules of Formula (IV):
YRₙ n=2 or 3 (I)
where Y is a N-, S- or P-atom and each R is independently selected from the group consisting of a H-atom and an alkyl group;
ZR′ₘ m=2 or 3 (II)
where Z is a N-, S- or P-atom and each R′ is independently selected from the group consisting of a H-atom and a silane group of Formula (III), and at least one R′ is the silane group of Formula (III):
SiR″₃ (III)
where each R″ is independently an alkyl group; and
R′″SiX₄ (IV)
where R′″ is selected from the group consisting of a H-atom, an OH-group, a Cl-atom and an alkoxy group, and each X is independently selected from the group consisting of a H-atom, an OH-group, a Cl-atom, an alkoxy group, an alkyl group and an organic group comprising at least one metal binding group; and
fluorinated precursors comprise crosslinked fluorinated organic molecules having functional groups comprising at least amine, diamine, triamine, tetraamine, polyamine, pyridine, imidazole, carboxylic acid, sulfonic acid, phosphate, phosphonate, and/or phenol; and
a plurality of the conductive lines printed on said at least one layer formed on the ground substrate.
